(19) United States
(12) Patent Application Publication
(10) Pub. No.: US 2005/0139548 A1
(43) Pub. Date: Jun. 30, 2005

(54) Extraction and oxidation process

(75) Inventors: James Robert Clark, Phoenix, AZ (US); Benjamin R. Roberts, Los Altos, CA (US); John V. Pozniak, San Jose, CA (US)

Correspondence Address: The BOC Group, Inc., Legal Services - Intellectual Property, 575 Mountain Ave., Murray Hill, NJ, 07974, US

(73) Assignee: The BOC Group, Inc.

(21) Appl. No.: 10/749,955

(22) Filed: Dec. 31, 2003

(51) Int. Cl. C02F 1/28

(52) U.S. Cl. 210/674

(57) ABSTRACT

A process for extracting a borane compound from an adsorption resin and oxidizing said borane compound, the process comprising contacting the adsorption resin with a solution comprising at least one ketone and/or at least aldehyde, at least one alcohol and, optionally, water.

### FIELD OF THE INVENTION

The present invention relates to a process for extracting a borane compound from a separation medium, such as an adsorption resin, and oxidizing the extracted borane compound to convert it to another chemical species.

### BACKGROUND

Electroless plating, also known as electroless deposition, is a process for depositing a layer of a conductive material, such as a metal, from a plating solution onto a substrate without the application of electrical current.

Electroless plating is commonly used in the semiconductor processing industry to deposit or “plate” a layer of a conductive metal from a plating solution onto a semiconductor wafer. Electroless plating solutions often include a reducing agent which reduces the metal in the plating solution to cause the metal to be deposited or to “plate out” over the target surface of a substrate, such as the semiconductor wafer.

Electroless plating processes involve the use of solutions or “baths” of chemicals, including, for example, metals and reducing agents. The used electroless plating solutions typically contain residual amounts of these chemicals, thereby presenting waste disposal problems. Consequently, the electroless plating waste solutions have been found to be capable of generating flammable hydrogen gas after they have been discarded. The source of hydrogen gas appears to be attributed to the reduction of water by the residual reducing agents in the plating solution.

Therefore, it is desirable to treat or remove the reducing agents, such as dimethylamine borane, from the electroless plating waste solutions prior to disposal of the used plating solutions.

Prior processes for extracting borane compounds from industrial waste streams utilize neat solutions of acetone, which is highly flammable, and is not very efficient at extracting the borane compounds from the separation medium or oxidizing the extracted borane compounds.

U.S. Patent Application Publication No. 2003/0085177 discloses a process for treating an electroless plating waste containing a metal and a reducing agent comprising: containing the waste in a container; decreasing an ability for the reducing agent to reduce the metal, resulting in a release of a gas from the waste in the container at a rate which is higher than without the decrease in the ability for the reducing agent to reduce the metal, the gas being contained in an enclosed volume; exhausting the gas from the enclosed volume; and draining the waste from the container.

### SUMMARY

A process is provided for extracting a borane compound from a separation medium and oxidizing said borane compound, the process comprising contacting the separation medium with a solution comprising at least one compound of the formula R₁—CO—R₂, wherein R₁ is selected from hydrogen or an alkyl group having from 1 to about carbon 6 atoms and wherein R₂ is selected from an alkyl group having from 1 to about carbon 6 atoms, and at least one diluent.

In certain embodiments, the diluent comprises at least one alcohol, or a mixture of at least one alcohol and water.

In another embodiment, the process for extracting a borane compound from a separation medium and oxidizing said borane compound, comprises contacting the separation medium with a solution comprising at least one ketone, at least one alcohol and, optionally, water. The process is useful to extract borane compounds from adsorption resins.

In one embodiment, the separation medium is an adsorption resin manufactured from polymeric materials.

The at least one ketone is present in the solution an amount from about 10 to about 50 percent by volume and the at least alcohol is present in the solution in amount from about 50 to about 90 percent by volume.

The solution utilized to extract borane compounds from the separation medium and to oxidize the extracted borane compounds may, in one embodiment, include acetone as the ketone and isopropanol as the alcohol.

### DETAILED DESCRIPTION

In the semiconductor materials processing industry, electroless plating processes generate high volumes of waste streams. Upon completion of the electroless plating process, the waste stream may be passed through a separation medium to remove certain compounds prior to disposal of the waste stream. A process is provided to recover these compounds from the separation medium and to convert the compounds to more environmentally acceptable chemical species.

A process for extracting a borane compound from a separation medium, such as an adsorption resin, and oxidizing the extracted borane compound is provided. The process includes contacting a separation medium with a solution comprising at least one compound of the formula R₁—CO—R₂, wherein R₁ is selected from hydrogen or an alkyl group having from 1 to about 6 carbon atoms and wherein R₂ is selected from an alkyl group having from 1 to about 6 carbon atoms, and at least one diluent.

The term “regeneration solution” refers to a solution that is capable of extracting borane compounds from a separation media and converting the extracted borane compounds, via an oxidation reaction, to desired chemical species.

The regeneration solution may comprise (i) at least one ketone and at least one diluent, (ii) at least one aldehyde and at least one diluent, or (iii) at least one ketone, at least aldehyde and at least one diluent. Accordingly, wherein R₁ is hydrogen and R₂ is an alkyl group having from 1 to about 6 carbon atoms, then the chemical structure R₁—CO—R₂ represents an aldehyde, and wherein R₁ is selected from an alkyl group having from 1 to about 6 carbon atoms and R₂ is selected from an alkyl group having from 1 to about 6 carbon atoms, then the chemical structure R₁—CO—R₂ represents a ketone.

In addition to the ketone and/or aldehyde, the regeneration solution also includes at least one diluent. Preferably, the diluent acts as a flammability reducing agent. The term “flammability reducing agent” refers to an agent that is included in the regeneration solution that reduces the overall flammability of the regeneration solution. Without limitation, the diluent may be selected from water or a water soluble alcohol.

The process may be used to extract borane reducing agents, such as dimethylamine borane, from an adsorption medium containing industrial waste, such as from the semiconductor processing industry. As the dimethylamine borane is extracted from the adsorption resin, it is oxidized to boric acid.

According to certain embodiments, the regeneration solution includes at least one ketone and at least one alcohol. The ketone may be present in the regeneration solution in an amount from about 10 to about 50 percent by volume and the alcohol may be present in the solution in an amount from about 50 to about 90 percent by volume.

In other embodiments, the ketone may be present in the regeneration solution in an amount from about 25 to about 50 percent by volume and the alcohol may be present in the regeneration solution in an amount from about 50 to about 75 percent by volume.

One particularly useful formulation for the regeneration solution includes a solution of at least one ketone in an amount of about 50 percent by volume and at least one alcohol in an amount of about 50 percent by volume.

The process for extracting borane compounds from an adsorption resin and oxidizing the extracted borane compounds may also include contacting an adsorption resin with a regeneration solution including at least one ketone, at least one alcohol, and water.

The ketone may be present in the regeneration solution in an amount from about 40 to about 45 percent by volume, the alcohol may be in the regeneration solution in amount from about 40 to about 45 percent by volume and water may be present in the regeneration solution in amount from about 5 to about 20 percent by volume.

If water is present in the regeneration solution, one particularly useful formulation for the regeneration solution includes at least one ketone in an amount of about 45 percent by volume, at least one alcohol in an amount of about 45 percent by volume, and water in an amount of about 10 percent by volume.

If the regeneration solution includes ketones or a combination of ketones and aldehydes, then, without limitation, the ketones that may be utilized may be selected from acetone, dihydroxyacetone, glucose, fructose, dextrose, sucrose, and mixtures thereof.

If the regeneration solution includes aldehydes alone, or in combination with ketones, then, without limitation, the aldehydes that may be utilized include formaldehyde, acetaldehyde, glyoxal, glyoxylic acid and mixtures thereof.

The alcohols that may be utilized in the regeneration solution may be selected from methanol, ethanol, n-propanol, isopropanol, ethylene glycol, propylene glycol, glycerol, and mixtures thereof.

In certain embodiments, the solution includes a mixture of acetone and isopropanol. The acetone may be generally present in an amount from about 10 to about 50 percent by volume and the isopropanol may be generally present in an amount from about 50 to about 90 percent by volume. Preferably, the acetone is present in the regeneration solution in an amount from about 25 to about 50 percent by volume and isopropanol is present in the regeneration in an amount from about 75 to about 50 percent by volume. A particularly useful regeneration solution includes acetone in an amount of about 50 percent by volume and isopropanol in an amount of about 50 percent by volume.

In other embodiments, the regeneration solution includes a mixture of acetone, isopropanol, and water. The acetone may be present in an amount from about 40 to about 45 percent by volume, isopropanol may be present in an amount from about 40 to about 45 percent by volume, and water may be present in an amount from about 5 to about 20. A particularly useful regeneration solution includes acetone in an amount of about 45 percent by volume, isopropanol in an amount of about 45 percent by volume, and water in an amount of about 10 percent by volume.

For purposes of illustration, but not by way of limitation, adsorption resins that can be treated by the regeneration solution to remove borane compounds and to oxidize the removed compounds to boric acid include, but are not limited to any adsorption resin that is capable of separating a desired chemical species, such as dimethylamine borane, from an industrial waste solution. For example, the regeneration solution and process may be used to extract industrial waste species, such as dimethylamine borane, from adsorption resin manufactured from polymeric or inorganic materials. In certain embodiments, the regeneration solution may be used to extract borane compounds from OPTIPORE L493 adsorption resin, which is commercially available from The Dow Chemical Company. OPTIPORE L493 adsorption resin is manufactured from an adsorbent styrenic polymer resin. OPTIPORE L493 resin has a BET surface area of 1100 m²/g and is insoluble is strong acids, strong bases and organic solvents. In one preferred embodiment, the regeneration solution and process is used to extract an industrial waste species, such as dimethylamine borane, from an adsorption resin manufactured from polymeric materials.

While the regeneration solution and process may be utilized to extract and convert various chemical compounds from many different separation media, the solution and process finds applicability in the extraction of reducing agents that are used in a electroless plating process in the semiconductor processing industry from an adsorption resin.

For example, after an electroless plating process, the electroless plating waste stream is passed through a separation medium to remove respective components from the waste stream. After the separation medium is spent, in order to regenerate the separation medium to process additional waste streams, the media is treated to remove the adsorbed compounds from the waste stream and to render the waste stream more benign for further processing or disposal.

The regeneration solution and process may be utilized to extract a reducing agent, such as dimethylamine borane, from an adsorption resin. As the dimethylamine borane is extracted from the adsorption resin, it is converted by oxidation to boric acid and other chemical by-products, such as dimethylamine.

### EXAMPLES

The following examples are set forth to further illustrate the various embodiments of the process. The examples should not be construed as limiting the process in any manner.

### Example 1

### 10% Acetone by Volume in Isopropanol

The effectiveness of a regeneration solution comprising 10 percent acetone by volume in isopropanol in extracting dimethylamine borane (DMAB) from a resin packed column and oxidizing the extracted DMAB was evaluated.

Preparation of a Cobalt Electroless Plating Solution

A cobalt electroless plating solution was prepared by combining together 45 grams of CaCl₂.6H₂O, 85.5 grams of citric acid monohydrate, and 75 grams of NH₄Cl. The combined ingredients were diluted to 600 ml with deionized water. To this solution, 500 ml of 25% aqueous tetramethylammonium hydroxide (TMAH) was added. 3 grams of ammonium hypophosphite and 30 grams of dimethylamine borane (DMAB) was added to the solution. Finally, 210 ml of TMAH was added and the solution was diluted to 1500 ml with deionized water. The resulting test cobalt electroless plating solution had a pH of 9.21.

A column was packed with a adsorption separation resin manufactured from a polymeric material. 250 ml of the test cobalt electroless plating solution described above was poured into the top of the resin-packed column and was allowed to flow through the column by gravity. After pouring the test cobalt plating solution into the column, 500 ml of deionized water, followed by 250 ml of a regeneration solution comprising 10 percent acetone by volume in isopropanol (i.e.—10% acetone/90% isopropanol) was poured into the top of the resin packed column. Shortly after the introduction of the regeneration solution into the column, 750 ml of deionized water was poured into the column.

Several fractions of eluent were collected from the bottom of the resin packed column. The collected fractions were analyzed for the presence of cobalt and boron by inductively coupled plasma mass spectroscopy and boron NMR. The process utilizing a regeneration solution comprising 10 percent acetone by volume in isopropanol achieved extraction of 100% of DMAB from the test plating solution. The process was successful in oxidizing 46.2% of the extracted DMAB to boric acid.

### Example 2

### 10% Acetone by Volume in Water

A regeneration solution comprising 10% acetone by volume in water was evaluated for its ability to extract DMAB from the test cobalt electroless plating solution prepared in Example 1, above, and to oxidize to the extracted DMAB to boric acid.

A column was packed with an adsorption separation resin manufactured from a polymeric material. 250 ml of the test cobalt electroless plating solution described above was poured into the top of the resin-packed column and was allowed to flow through the column by gravity. After pouring the test cobalt plating solution into the column, 500 ml of deionized water, followed by 250 ml of a regeneration solution comprising 10 percent acetone by volume in water (i.e.—10% acetone/90% water) was poured into the top of the resin packed column. Shortly after the introduction of the regeneration solution into the column, 750 ml of deionized water was poured into the column.

Several fractions of eluent were collected from the bottom of the resin packed column. The collected fractions were analyzed for the presence of cobalt and boron by inductively coupled plasma mass spectroscopy and boron NMR. The process utilizing a regeneration solution comprising 10 percent acetone by volume in water achieved extraction of 30.7% of DMAB from the test plating solution. The process was successful in oxidizing 95.9% of the extracted DMAB to boric acid.

### Example 3

### 50% Acetone by Volume in Isopropanol Regeneration Solution

Preparation of a Cobalt Electroless Plating Solution

A cobalt electroless plating solution was prepared by combining together 30 grams of CaCl₂.6H₂O, 57 grams of citric acid monohydrate, and 50 grams of NH₄Cl. The combined ingredients were diluted to 400 ml with deionized water. To this solution, 355 ml of 25% aqueous tetramethylammonium hydroxide (TMAH) was added. 2 grams of ammonium hypophosphite and 20 grams of dimethylamine borane (DMAB) was added to the solution. Finally, 105 ml of TMAH was added and the solution was diluted to 1 liter with deionized water. The resulting test cobalt electroless plating solution had a pH of 9.13.

A column was packed with a adsorption separation resin manufactured from a polymeric material. 250 ml of the test cobalt electroless plating solution described above was poured into the top of the resin-packed column and was allowed to flow through the column by gravity. After pouring the test cobalt plating solution into the column, 500 ml of deionized water, followed by 250 ml of a regeneration solution comprising 50 percent acetone by volume in isopropanol (i.e.—50% acetone/50% isopropanol) was poured into the top of the resin packed column. Shortly after the introduction of the regeneration solution into the column, 750 ml of deionized water was poured into the column.

Several fractions of eluent were collected from the bottom of the resin packed column. The collected fractions were analyzed for the presence of cobalt and boron by inductively coupled plasma mass spectroscopy and boron NMR. The process utilizing a regeneration solution comprising 50 percent acetone by volume in isopropanol achieved extraction of 92.1 % of DMAB from the test plating solution. The process was successful in oxidizing 100% of the extracted DMAB to boric acid.

### Example 4

### 45% Acetone/45% Isopropanol/10% Water by Volume Regeneration Solution

A regeneration solution comprising 45% acetone/45% isopropanol/10% water by volume was evaluated for its ability to extract DMAB from the test cobalt electroless plating solution prepared in Example 3, above, and to oxidize to the extracted DMAB to boric acid.

A column was packed with an adsorption separation resin manufactured from a polymeric material. 250 ml of the test cobalt electroless plating solution described above was poured into the top of the resin-packed column and was allowed to flow through the column by gravity. After pouring the test cobalt plating solution into the column, 500 ml of deionized water, followed by 250 ml of a regeneration solution comprising 45% acetone/45% isopropanol/10% water was poured into the top of the resin packed column. Shortly after the introduction of the regeneration solution into the column, 750 ml of deionized water was poured into the column.

Several fractions of eluent were collected from the bottom of the resin packed column. The collected fractions were analyzed for the presence of cobalt and boron by inductively coupled plasma mass spectroscopy and boron NMR. The process utilizing a regeneration solution comprising 45% acetone/45% isopropanol/10% water achieved extraction of 95.4% of DMAB from the test plating solution. The process was successful in oxidizing 100% of the extracted DMAB to boric acid.

### Example 5

### 100% Acetone Solution vs. 45% Acetone/45% Isopropanol/10% Water

The process of extracting DMAB from an adsorption resin and oxidizing the extracted DMAB using a regeneration solution comprising a blend of 45% acetone/45% isopropanol/10% water by volume was compared to a regeneration solution comprising 100% acetone.

A 80 cm tall (2.22 cm inner diameter) column was packed with an adsorption separation resin manufactured from a polymeric material. A test cobalt electroless plating solution containing the reducing agent DMAB was prepared. 250 ml of the test cobalt electroless plating solution was poured into the top of the resin-packed column and was gravity fed through the column. After pouring the test cobalt plating solution into the column, 750 ml of deionized water, followed by 250 ml of either the 100% acetone or the 45% acetone/45% isopropanol/10% water regeneration solution was poured into the top of the resin packed column. Shortly after the introduction of the regeneration solution into the column, 750 ml of deionized water was poured into the column.

Eight 250 ml fractions of eluent from each of the 100% acetone run and the 45% acetone/45% isopropanol/10% water (“Blend” fractions) run were collected from the bottom of the resin packed column. The collected fractions were analyzed for the presence of cobalt and boron. The amount of cobalt and boron extracted from the adsorption resin was analyzed by inductively coupled plasma mass spectroscopy (ICPMS). The conversion of DMAB to boric acid by oxidation was measured by boron NMR. The results are set forth in Table I below.

TABLE I

| Fraction | Cobalt (ppm) | Boron (ppm) |
|---|---|---|
| Acetone 1 | 1760 | 148 |
| Acetone 2 | 6210 | 774 |
| Acetone 3 | 458 | 103 |
| Acetone 4 | 23 | 17 |
| Acetone 5 | 1 | 2570 |
| Acetone 6 | 0 | 462 |
| Acetone 7 | 0 | 2 |
| Acetone 8 | 0 | 1 |
| Blend 1 | 1710 | 152 |
| Blend 2 | 4680 | 646 |
| Blend 3 | 332 | 95 |
| Blend 4 | 8 | 18 |
| Blend 5 | 0 | 3030 |
| Blend 6 | 0 | 305 |
| Blend 7 | 0 | 2 |
| Blend 8 | 0 | 0 |

As show in Table I, the vast majority of boron from the test cobalt electroless plating solution, and extracted from the adsorption resin, was eluted in Acetone fractions 5 and 6 and in Blend fractions 5 and 6. Therefore, these fractions were selected for boron NMR analysis to measure the conversion of DMAB. The results are shown in Table II below.

TABLE II

| Fraction | Day 1 | Day 2 |
|---|---|---|
| Acetone 5 | 7% | 13% |
| Acetone 6 | 0% | 0% |
| Blend 5 | 39% | 14% |
| Blend 6 | 7% | 0% |

The results in Table II are the percentage of boron detected by boron NMR that is in the form of DMAB. Day 1 boron NMR measurements are taken 2-3 hours after elution of the fraction tested. Day 2 measurements were conducted 24 hours after Day 1 measurements. As Table II shows, the regeneration solution comprising a blend of 45% acetone/45% isopropanol/10% water by volume is effective in oxidizing DMAB to boric acid, when compared to a neat solution of acetone.

Oxidation of the reducing agents, such as dimethylamine borane, contained in the waste stream renders the reducing agents incapable of generating any hydrogen. Accordingly, use of the present process substantially prevents the formation of hydrogen gas by the constituents of the used electroless plating solutions.

Without being bound to any particular theory, it is believed that the inclusion of an alcohol in the regeneration solution promotes more efficient extraction of the organoboron compounds from the separation media, and decreases the flammability of the ketone in the regeneration solution.

The regeneration solution and process can be used to treat a wide variety of spent electroless plating solutions containing reducing agents, such as, for example, nickel, cobalt, copper, silver, gold, platinum or palladium electroless plating solutions.

The regeneration solution and process efficiently and cost-effectively extracts organoboron compounds from adsorption media containing organoboron compounds from the waste streams of semiconductor electroless plating processes. The process also efficiently oxidizes the extracted organoboron compounds to boric acid. The present process is advantageous over prior processes in that the extraction/oxidation solution used is less flammable than the solutions of prior processes. Furthermore, the solution utilized in the present process is more effective in removing organoboron compounds from adsorption resins and oxidizing the extracted compounds into more environmentally acceptable compounds.

It should be understood that the embodiments described herein are merely exemplary and that a person skilled in the art may make many variations and modifications without departing from the spirit and scope of the invention. All such variations and modifications are intended to be included within the scope of the invention as described herein. It should be understood that any embodiments described above are not only in the alternative, but can be combined.

1. A process for extracting a borane compound from a separation medium and oxidizing said borane compound, the process comprising contacting the separation medium with a regeneration solution comprising at least one compound of the formula R₁—CO—R₂, wherein R₁ is selected from hydrogen or an alkyl group having from 1 to about 6 carbon atoms and wherein R₂ is selected from an alkyl group having from 1 to about 6 carbon atoms, and at least one diluent.

2. The process of claim 1 wherein said at least one compound of the formula R—CO—R₂ is a ketone.

3. The process of claim 2 wherein said ketone is selected from the group consisting of acetone, dihydroxyacetone, fructose, dextrose, sucrose and mixtures thereof.

4. The process of claim 1 wherein said at least one compound of the formula R₁—CO—R₂ is an aldehyde.

5. The process of claim 4 wherein said aldehyde is selected from the group consisting of formaldehyde, acetaldehyde, glyoxal, glyoxylic acid and mixtures thereof.

6. The process of claim 1 wherein said at least one compound of the formula R₁—CO—R₂ is present in an amount from about 10 to about 50 percent by volume and wherein said diluent is present in an amount from about 50 to about 90 percent by volume.

7. The process of claim 6 wherein said at least one compound of the formula R₁—CO—R₂ is present in an amount from about 25 to about 50 percent by volume and wherein said diluent is present in an amount from about 75 to about 50 percent by volume.

8. The process of claim 7 wherein said at least one compound of the formula R₁—CO—R₂ is present in an amount of about 50 percent by volume and wherein said diluent is present in an amount of about 50 percent by volume.

9. The process of claim 2 wherein said diluent comprises at least one alcohol.

10. The process of claim 9 wherein said alcohol is selected from the group consisting of methanol, ethanol, n-propanol, isopropanol, ethylene glycol, propylene glycol, glycerol, and mixtures thereof.

11. The process of claim 11 wherein said ketone is acetone and said alcohol is isopropanol.

12. The process of claim 11 wherein said acetone is present in an amount from about 10 to about 50 percent by volume and wherein said isopropanol is present in an amount from about 50 to about 90 percent by volume.

13. The process of claim 11 wherein said acetone is present in an amount from about 25 to about 50 percent by volume and wherein said isopropanol is present in an amount from about 75 to about 50 percent by volume.

14. The process of claim 13 wherein said acetone is present in an amount of about 50 percent by volume and wherein said isopropanol is present in an amount of about 50 percent by volume.

15. The process of claim 1 wherein said separation medium is an adsorption resin.

16. The process of claim 1 wherein the diluent includes at least one alcohol and water.

17. The process of claim 16 wherein said at least one compound of the formula R₁—CO—R₂ is present in an amount from about 40 to about 45 percent by volume, wherein the alcohol is present in amount from about 40 to about 45 percent by volume and wherein water is present in amount from about 5 to about 20 percent by volume.

18. The process of claim 17 wherein said at least one compound of the formula R₁—CO—R₂ is present in an amount of about 45 percent by volume, wherein the alcohol is present in amount of about 45 percent by volume and wherein water is present in amount from of about 10 percent by volume.

19. The process of claim 17 wherein said at least one compound of the formula R₁—CO—R₂ is a ketone selected from the group consisting of acetone, dihydroxyacetone, fructose, dextrose, sucrose and mixtures thereof, or an aldehyde selected from the group consisting of formaldehyde, acetaldehyde, glyoxal, glyoxylic acid and mixtures thereof.

20. The process of claim 17 wherein said alcohol is selected from the group consisting of methanol, ethanol, n-propanol, isopropanol, ethylene glycol, propylene glycol, glycerol, and mixtures thereof.

21. The process of claim 20 wherein said at least one compound of the formula R₁—CO—R₂ is a ketone and said ketone is present in an amount of about 45 percent by volume, wherein said alcohol is isopropanol and said isopropanol is present in amount of about 45 percent by volume, and wherein water is present in amount from of about 10 percent by volume.

22. The process of claim 2 wherein the borane compound is dimethylamine borane.

23. The process of claim 22 wherein said at least one compound of the formula R₁—CO—R₂ is acetone and wherein said diluent is isopropanol.

24. The process of claim 23 wherein the of said acetone present in the solution is 10 percent by volume and wherein the amount of isopropanol in the solution is 90 percent by volume.

25. The process of claim 23 wherein the of said acetone present in the solution is 50 percent by volume and wherein the amount of isopropanol in the solution is 50 percent by volume.

26. The process of claim 22 wherein said at least one compound of the formula R₁—CO—R₂ is acetone and wherein said diluent is water.

27. The process of claim 26 wherein the of said acetone present in the solution is 10 percent by volume and wherein the amount of water in the solution is 90 percent by volume.

28. The process of claim 22 wherein said at least one compound of the formula R₁—CO—R₂ is acetone and wherein said diluent is a mixture of isopropanol and water.

29. The process of claim 28 wherein the of said acetone present in the solution is 45 percent by volume, wherein the amount of isopropanol in the solution is 45 percent by volume, and wherein the amount of water present in the solution 10 percent by volume.
